(19) United States
(12) Patent Application Publication
(10) Pub. No.: US 2020/0251738 A1
(43) Pub. Date: Aug. 6, 2020

(54) NEGATIVE ELECTRODE FOR LITHIUM ION SECONDARY BATTERY

(71) Applicant: TOYOTA JIDOSHA KABUSHIKI KAISHA, Toyota-shi (JP)

(72) Inventors: Yutaka OYAMA, Toyota-shi (JP); Yuji YOKOYAMA, Kobe-shi (JP); Naoto ONODERA, Kobe-shi (JP)

(21) Appl. No.: 16/749,729

(22) Filed: Jan. 22, 2020

(30) Foreign Application Priority Data
Feb. 1, 2019 (JP) 2019-017106

(51) Int. Cl. H01M 4/62; H01M 10/0525; H01M 4/36; H01M 10/0565

(52) U.S. Cl. CPC H01M 4/62; H01M 10/0525; H01M 2004/027; H01M 10/0565; H01M 4/362

(57) ABSTRACT

According to the present disclosure, there is provided a technique capable of suitably reducing the battery resistance of a lithium ion secondary battery. In an aspect of a negative electrode disclosed herein, a negative electrode active material layer contains a negative electrode active material, a binder which includes a water-soluble polymer lithium salt, and a sub-material particle including a metal compound which has a hydroxyl group. With this, hopping conduction in which a Li ion moves in such a manner as to slide on hydroxyl groups on the surface of the sub-material particle can occur, and hence it is possible to accelerate supply of the Li ion to the negative electrode active material and achieve a significant reduction in the battery resistance of the lithium secondary battery.

### CROSS REFERENCE TO RELATED APPLICATIONS

The present application claims priority based on Japanese Patent Application No. 2019-017106 filed on Feb. 1, 2019, the entire contents of which are incorporated herein by reference in its entirety.

### BACKGROUND

### 1. Technical Field

The present disclosure relates to a negative electrode for a lithium ion secondary battery.

### 2. Description of the Related Art

Lithium ion secondary batteries are lighter and higher in energy density than existing batteries, and hence, in recent years, the lithium ion secondary batteries are used as a so-called portable power source of a personal computer or a cellular phone, and a power source for driving a vehicle. The lithium ion secondary battery is expected to become increasingly prevalent in the future particularly as a high output power source for driving a vehicle such as an electric vehicle (EV), a hybrid vehicle (HV), or a plug-in hybrid vehicle (PHV).

A negative electrode used in the lithium ion secondary battery typically has a configuration in which a negative electrode active material layer is provided on a negative electrode current collector. The negative electrode active material layer typically contains a negative electrode active material. As the negative electrode active material, it is possible to use a carbon-based material or the like capable of inserting and extracting a lithium ion serving as a charge carrier. In addition, the negative electrode active material layer of the lithium ion secondary battery can contain various materials other than the negative electrode active material.

For example, the negative electrode active material layer described above contains a binder for binding the negative electrode active materials together and binding the negative electrode active material and the negative electrode current collector together. As the binder for the negative electrode of the lithium ion secondary battery, polyvinylidene fluoride (PVdF), polyvinyl pyrrolidone (PVP), polyvinyl alcohol (PVA), or carboxymethyl cellulose (CMC) is used. As another example of the binder, Japanese Patent Application Publication No. 2014-22039 discloses a carboxymethyl cellulose lithium salt (CMC-Li). CMC-Li mentioned above has high adhesion to a current collector, and hence it is possible to improve the electrochemical stability of the lithium ion secondary battery.

In addition, the negative electrode active material layer can contain an additive (sub-material) other than the binder. As an example of the sub-material mentioned above, Japanese Patent Application Publication No. 2017-174664 discloses a material having a compression modulus higher than that of the negative electrode active material. By adding the sub-material having the high compression modulus to the negative electrode active material layer, it is possible to reduce unevenness in the amount of an electrolyte solution in the negative electrode active material layer, and improve high-rate charge and discharge characteristics. Note that, in Japanese Patent Application Publication No. 2017-174664, preferred examples of the above sub-material include alumina, boehmite, zirconia, magnesia, and aluminum hydroxide.

### SUMMARY

Incidentally, in the field of the lithium ion secondary battery, with a request for an improvement in battery performance in recent years, development of a technique capable of reducing battery resistance to a level lower than a conventional level is demanded. In particular, the lithium ion secondary battery for driving a vehicle is used in a low temperature environment at high frequency and rapid charge and discharge are often performed, and hence a significant reduction in battery resistance is demanded.

The present disclosure has been made in view of such points, and an object thereof is to provide a technique cable of suitably reducing the battery resistance of the lithium ion secondary battery.

In order to achieve a reduction in the battery resistance of the lithium ion secondary battery, the inventors of the present disclosure have conceived of developing a technique for accelerating supply of a Li ion to the negative electrode active material. As a result of various studies, the inventors have obtained amazing knowledge that, when two kinds of additives which are considered to increase the battery resistance are used in combination, the supply of the Li ion to the negative electrode active material is accelerated, and the battery resistance is significantly reduced. Hereinbelow, a specific description will be made.

As disclosed in Japanese Patent Application Publication No. 2014-22039, it is known that, in order to improve adhesion between the negative electrode active material layer and the current collector, a water-soluble polymer lithium salt such as the carboxymethyl cellulose lithium salt (CMC-Li) is used as the binder. However, when the water-soluble polymer lithium salt is added to the negative electrode active material layer, the battery resistance may increase. Specifically, a binder 118 including the water-soluble polymer lithium salt such as CMC-Li which is used in a negative electrode active material layer 114 shown in FIG. 3 has positively polarized (δ⁺) lithium. Consequently, there are cases where the Li ion (Li⁺) in an electrolyte solution and the binder 118 repel one another, and the supply of the Li ion to a negative electrode active material 116 is inhibited. Consequently, the binder including CMC-Li or the like can be a cause of an increase in battery resistance.

In addition, as disclosed in Japanese Patent Application Publication No. 2017-174664, it is known that, in order to reduce unevenness in the amount of the electrolyte solution in the negative electrode active material layer, a sub-material particle including alumina or boehmite is added to the negative electrode active material layer. However, also in the case where the sub-material particle mentioned above is used, the battery resistance may increase.

Specifically, a sub-material particle 219 including alumina or the like which is used in a negative electrode active material layer 214 shown in FIG. 4 has a hydroxyl group (—OH) on its surface. The hydroxyl group (—OH) of the sub-material particle 219 has a negatively polarized (δ⁻) oxygen atom, and hence the Li ion (Li⁺) in the electrolyte solution is attracted to the sub-material particle 219. At this point, the Li ion attracted to the sub-material particle 219 attempts to substitute for Na of a binder (e.g., CMC) 218. However, the moving speed of Na⁺ is low, and hence the supply of the Li ion to a negative electrode active material 216 is hindered. Consequently, the sub-material particle including alumina or the like can also be a cause of an increase in battery resistance.

The inventors of the present disclosure have focused attention on a supply path of the Li ion when the two kinds of additives described above are used. Consequently, the inventors have discovered that, when the additives which can be causes of an increase in battery resistance are used in combination, the supply of the Li ion to the negative electrode active material is accelerated, and the battery resistance is significantly reduced.

Specifically, as shown in FIG. 1, the inventors have conceived of adding the water-soluble polymer lithium salt as a binder 18, and adding a metal compound (alumina or the like) having the hydroxyl group as a sub-material particle 19. A reason why this accelerates the supply of the Li ion to a negative electrode active material 16 is presumably as follows. The hydroxyl group (—OH) of the sub-material particle 19 has the negatively polarized oxygen atom, and hence the Li ion (Li⁺) in the electrolyte solution is attracted to the surface of the sub-material particle 19. At this point, in the case where the water-soluble polymer lithium salt is used as the binder 18, the Li ion attracted to the sub-material particle 19 substitutes for lithium of the binder 18, and the Li ion is released from the binder 18. Subsequently, a continuous movement of the Li ion in which, when the oxygen atom of the hydroxyl group of the sub-material particle 19 receives the released Li ion, the oxygen atom thereof transfers the Li ion to the oxygen atom of the adjacent hydroxyl group (hopping conduction) occurs. The inventors have assumed that the supply of the Li ion to the negative electrode active material 16 is accelerated by the hopping conduction. As a result of a test conducted by the inventors, the inventors have discovered that the battery resistance is significantly reduced.

A negative electrode for a lithium ion secondary battery disclosed herein (hereinafter also simply referred to as a “negative electrode”) has been invented based on the above knowledge. The negative electrode includes a negative electrode current collector, and a negative electrode active material layer provided on the surface of the negative electrode current collector. The negative electrode active material layer contains a negative electrode active material including a material capable of inserting and extracting of a lithium ion, a water-soluble polymer lithium salt, and a sub-material particle including a metal compound which has a hydroxyl group.

As described above, according to the negative electrode disclosed herein, the supply of the Li ion to the negative electrode active material is accelerated by the hopping conduction, and hence it is possible to achieve a significant reduction in the battery resistance of the lithium ion secondary battery.

In a preferred aspect of the negative electrode disclosed herein, the sub-material particle includes at least one selected from the group consisting of a metal oxide and a metal hydroxide.

In the case where such a material is used as the sub-material particle, it is possible to reduce the battery resistance more suitably by allowing the hopping conduction of the Li ion on the surface of the sub-material particle to appropriately occur. Note that preferred examples of the material of the sub-material particle include alumina, boehmite, aluminum hydroxide, zirconia, and magnesia.

In a preferred aspect of the negative electrode disclosed herein, the water-soluble polymer lithium salt includes at least one selected from the group consisting of a carboxymethyl cellulose lithium salt, a polyacrylic acid lithium salt, and an alginic acid lithium salt.

By using these materials as the water-soluble polymer lithium salt, it is possible to allow the hopping conduction to appropriately occur and reduce the battery resistance more suitably.

In a preferred aspect of the negative electrode disclosed herein, the D₅₀ particle diameter of the sub-material particle is not more than 1.5 μm.

In the negative electrode disclosed herein, as the particle diameter of the sub-material particle becomes smaller, the battery resistance of the lithium ion secondary battery tends to become lower. This is presumably because the movement distance of the Li ion supplied to the negative electrode active material is reduced by the hopping conduction. The inventors have conducted experiments from this viewpoint, and have determined that the battery resistance is reduced especially suitably in the case where the D₅₀ particle diameter of the sub-material particle is set to 1.5 μm or less.

In a preferred aspect of the negative electrode disclosed herein, a content of the water-soluble polymer lithium salt is 0.1 to 10 wt % when a total weight of the negative electrode active material layer is 100 wt %.

From the viewpoint of allowing the hopping conduction to suitably occur, the content of the water-soluble polymer lithium salt is preferably not less than 0.1 wt %. On the other hand, the water-soluble polymer lithium salt is a resistive element, and hence, when the content thereof is excessively high, the movement of the Li ion may be inhibited. Accordingly, the upper limit of the content of the water-soluble polymer lithium salt is preferably not more than 10 wt %.

In a preferred aspect of the negative electrode disclosed herein, a content of the sub-material particle is 1 to 20 wt % when the total weight of the negative electrode active material layer is 100 wt %.

From the viewpoint of allowing the hopping conduction to suitably occur, the content of the sub-material particle is preferably not less than 1 wt %. In addition, similarly to the water-soluble polymer lithium salt, the sub-material particle is also a resistive element, and hence, when the content thereof is excessively high, the movement of the Li ion may be inhibited. Accordingly, the upper limit of the content of the sub-material particle is preferably not more than 20 wt %.

In a preferred aspect of the negative electrode disclosed herein, a ratio of the content of the water-soluble polymer lithium salt to the content of the sub-material particle is 0.01 to 1.

In order to appropriately transfer the Li ion between the water-soluble polymer lithium salt and the sub-material particle to allow the hopping conduction to suitably occur, it is preferable to adjust the ratio of the content of the water-soluble polymer lithium salt to the content of the sub-material particle to an appropriate range. The inventors have determined by experiments that the battery resistance can be reduced more suitably in the case where the ratio thereof is set to 0.01 to 1.

### BRIEF DESCRIPTION OF THE DRAWINGS

FIG. 1 is a schematic view showing the surface of a negative electrode active material in a negative electrode according to an embodiment of the present disclosure;

FIG. 2 is a schematic view showing the cross-sectional structure of the negative electrode according to the embodiment of the present disclosure;

FIG. 3 is a schematic view showing the surface of a negative electrode active material in a conventional negative electrode; and

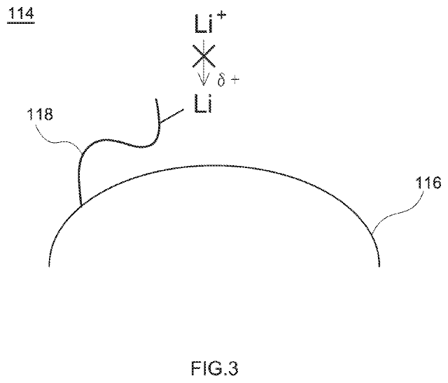

FIG. 4 is a schematic view showing the surface of a negative electrode active material in a conventional negative electrode.

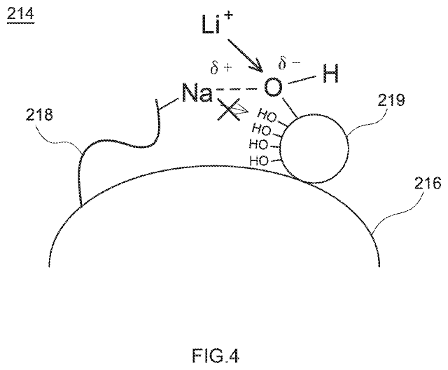

### DETAILED DESCRIPTION

Hereinbelow, a preferred embodiment of the present invention will be described. Note that, apart from matters which are specifically mentioned in the present specification, other matters which are necessary for implementation of the present invention (e.g., other components and typical manufacturing processes) can be understood as design matters of those skilled in the art based on the conventional art in the field. The present invention can be implemented based on contents disclosed in the present specification and common general technical knowledge in the field.

Negative Electrode for Lithium Ion Secondary Battery

A negative electrode for a lithium ion secondary battery disclosed herein includes at least a negative electrode current collector, and a negative electrode active material layer provided on the surface of the negative electrode current collector. The negative electrode disclosed herein is characterized in that the negative electrode active material layer contains a negative electrode active material, a water-soluble polymer lithium salt, and a sub-material particle including a metal compound which has a hydroxyl group. Note that other components are not particularly limited, and can be determined as needed based on various references.

Hereinbelow, the preferred embodiment of the present invention will be described with reference to the drawings appropriately. Note that, in the following drawings, members and portions which have the same functions are designated by the same reference numerals, and the repeated description thereof is sometimes omitted or simplified. The dimensional relationship (length, width, thickness, and the like) in the individual drawings may not necessarily reflect the actual dimensional relationship.

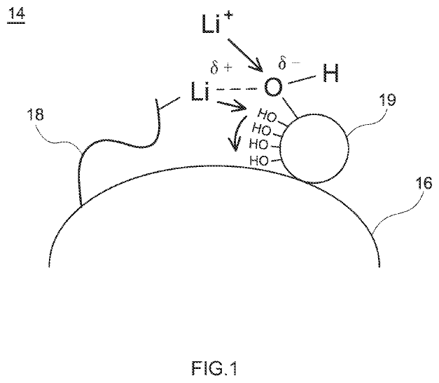

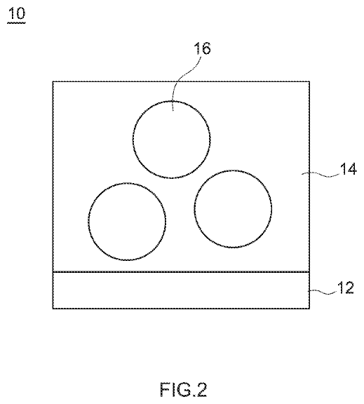

FIG. 1 is a schematic view showing the surface of the negative electrode active material in the negative electrode according to the present embodiment. In addition, FIG. 2 is a schematic view showing the cross-sectional structure of the negative electrode according to the present embodiment.

As shown in FIG. 2, a negative electrode 10 according to the present embodiment includes a negative electrode current collector 12, and a negative electrode active material layer 14 formed on the surface of the negative electrode current collector 12. As the negative electrode current collector 12, it is possible to use a metal material having excellent conductivity (e.g., copper, nickel, or the like). Note that the negative electrode active material layer 14 may be formed on one surface of the negative electrode current collector 12, or the negative electrode active material layers 14 may be formed on both surfaces thereof.

The negative electrode active material layer 14 of the present embodiment contains a negative electrode active material 16. The negative electrode active material 16 includes a material capable of inserting and extracting a lithium ion serving as a charge carrier. An example of the material of the negative electrode active material 16 includes a carbon-based material. As the carbon-based material, for example, graphite, hardly graphitizable carbon (hard carbon), and easily graphitizable carbon (soft carbon) are suitable. From the viewpoint of energy density or the like, graphite is especially preferable. Note that the present disclosure can also be applied to the case where a material other than the carbon-based material is used as the negative electrode active material 16. Examples of the material other than the carbon-based material include lithium titanate (LTO) and a silicon-based material (SiO).

The average particle diameter of the negative electrode active material 16 may be not more than 30 μm, may also be not more than 20 μm, and may also be not more than 15 μm.

From the viewpoint of causing a binder 18 and a sub-material particle 19 described later to suitably adhere to the surface of the negative electrode active material 16, it is preferable to reduce the average particle diameter of the negative electrode active material 16 and increase the specific surface area thereof. Note that the average particle diameter of the negative electrode active material 16 may be not less than 1 μm, may also be not less than 5 μm, and may also be not less than 10 μm.

As shown in FIG. 1, the negative electrode active material layer 14 in the present embodiment contains the binder 18. The binder 18 adheres to the surface of the negative electrode active material 16, and has the function of binding the negative electrode active materials 16 together and binding the negative electrode active material 16 and the negative electrode current collector 12 (see FIG. 2) together. In the present embodiment, the binder 18 includes a water-soluble polymer lithium salt. The water-soluble polymer lithium salt is synthesized by neutralizing an end group (e.g., a carboxy group) of a water-soluble polymer by using, e.g., lithium hydroxide. Examples of the water-soluble polymer lithium salt include a carboxymethyl cellulose lithium salt (CMC-Li), a polyacrylic acid lithium salt (PAA-Li), an alginic acid lithium salt, a polystyrene sulfonic acid lithium salt, and a polyvinyl sulfonic acid lithium salt. Preferred examples of the water-soluble polymer lithium salt include CMC-Li, PAA-Li, and the alginic acid lithium salt. By using these, hopping conduction of the Li ion on the surface of the sub-material particle 19 is allowed to appropriately occur to suitably accelerate supply of the Li ion to the negative electrode active material 16. Note that the material of the binder in the negative electrode disclosed herein should not be limited to those mentioned above, and can be used without particular limitations as long as the material thereof is the water-soluble polymer lithium salt.

In addition, the negative electrode active material layer 14 in the present embodiment contains the sub-material particle 19. The sub-material particle 19 is typically adhered to the surface of the negative electrode active material 16. The sub-material particle 19 includes a metal compound having a hydroxyl group (—OH). Examples of the metal compound having the hydroxyl group include metal oxides such as alumina, zirconia, and magnesia, and metal hydroxides such as boehmite, aluminum hydroxide, and magnesium hydroxide. By using these, the hopping conduction of the Li ion on the surface of the sub-material particle 19 is allowed to appropriately occur to suitably accelerate the supply of the Li ion to the negative electrode active material 16. Note that, from the viewpoint of preventing the hopping conduction from being inhibited by the insertion of the Li ion into the sub-material particle 19, the sub-material particle 19 is preferably a metal compound which does not allow the insertion and extraction of the lithium ion.

The Ds₅₀ particle diameter of the sub-material particle 19 may be not more than 1.5 nm, may also be not more than 1 μm, and may also be not more than 0.5 μm. As the particle diameter of the sub-material particle 19 becomes smaller, battery resistance tends to become lower. This is presumably because, when the particle diameter of the sub-material particle 19 is reduced, the movement distance of the Li ion by the hopping conduction is reduced. The lower limit of the D₅₀ particle diameter of the sub-material particle 19 may be not less than 0.01 μm, may also be not less than 0.05 μm, and may also be not less than 0.1 μm. Note that “the D₅₀ particle diameter of the sub-material particle” in the present specification is a median diameter (cumulative 50% particle diameter) calculated based on a volume-based particle diameter distribution. The volume-based particle diameter distribution can be measured by, e.g., a laser diffraction scattering method or the like.

As described above, according to the negative electrode 10 according to the present embodiment, the supply of the Li ion to the negative electrode active material 16 is accelerated, and hence it is possible to achieve a significant reduction in the battery resistance of the lithium ion secondary battery. Specifically, in the present embodiment, the negative electrode active material layer 14 contains the binder 18 which includes the water-soluble polymer lithium salt, and the sub-material particle 19 which has the hydroxyl group (—OH). The hydroxyl group of the sub-material particle 19 has a negatively polarized oxygen atom, and hence the Li ion in a nonaqueous electrolyte solution is attracted to the hydroxyl group of the sub-material particle 19. At this point, when the Li ion moves to the vicinity of the sub-material particle 19, the Li ion substitutes for lithium of the binder 18, and the Li ion is released from the binder 18. Subsequently, the Li ion released from the binder 18 is attracted to the hydroxyl group of the sub-material particle 19. Thereafter, the oxygen atom of the hydroxyl group of the sub-material particle 19 receives the Li ion, and transfers the Li ion to the adjacent hydroxyl group. The hopping conduction in which such a movement of the Li ion successively occurs arises on the surface of the sub-material particle 19, and the Li ion is supplied to the negative electrode active material 16 in such a manner as to slide on the surface of the sub-material particle 19. With this, the supply of the Li ion to the negative electrode active material 16 is accelerated, and hence it is possible to achieve a significant reduction in battery resistance.

In order to allow the hopping conduction of the Li ion to suitably occur, it is preferable to appropriately adjust the contents of the binder 18 and the sub-material particle 19 in the negative electrode active material layer 14.

Specifically, the content of the binder 18 which includes the water-soluble polymer lithium salt may be not less than 0.1 wt %, may also be not less than 0.5 wt %, may also be not less than 1 wt %, and may also be not less than 2 wt %. However, the water-soluble polymer lithium salt is a resistive element, and hence, when the addition amount thereof to the negative electrode active material layer 14 is excessively large, the movement of the Li ion may be inhibited. From this viewpoint, the upper limit of the content of the binder 18 which includes the water-soluble polymer lithium salt may be not more than 10 wt %, may also be not more than 9 wt %, may also be not more than 8 wt %, and may also be not more than 7 wt %.

Note that “the content of the water-soluble polymer lithium salt” in the present specification is a value when the total weight of the negative electrode active material layer is 100 wt %. “The content of the water-soluble polymer lithium salt” can be detected by an inductively coupled plasma (ICP) method which uses, e.g., an ICP emission spectral analyzer (model: ICPE-9800) manufactured by Shimadzu Corporation. In addition, qualitative analysis of the water-soluble polymer lithium salt can be performed by nuclear magnetic resonance spectroscopy (NMR) which uses an NMR apparatus (model: spectrometer Z) manufactured by JEOL Ltd.

The content of the sub-material particle 19 may be not less than 1 wt %, may also be not less than 2 wt %, may also be not less than 5 wt %, and may also be not less than 10 wt %. With this, it is possible to suitably generate the hopping conduction of the Li ion. In addition, similarly to the binder 18 (the water-soluble polymer lithium salt), the sub-material particle 19 (the metal compound having the hydroxyl group) is also a resistive element, and hence, when the addition amount thereof is excessively large, the movement of the Li ion tends to be inhibited. From this viewpoint, the upper limit of the content thereof is preferably not more than 20 wt %, more preferably not more than 18 wt %, further preferably not more than 16 wt %, and especially preferably not more than 15 wt %.

Note that “the content of the sub-material particle” in the present specification is a value when the total weight of the negative electrode active material layer is 100 wt %. “The content of the sub-material particle” can be detected by X-ray fluorescence (XRF) analysis which uses a fully automated multipurpose X-ray diffractometer (model: SmartLab) manufactured by Rigaku Corporation. In addition, qualitative analysis of the sub-material particle 19 which includes the metal compound having the hydroxyl group can be performed by X-ray diffraction (XRD) which uses a fluorescent X-ray analyzer (model: ZSX Primus IV) manufactured by Rigaku Corporation.

In order to appropriately transfer the Li ion between the binder 18 and the sub-material particle 19 to allow the hopping conduction to suitably occur, it is preferable to adjust the ratio of the content of the binder (the water-soluble polymer lithium salt) 18 to the content of the sub-material particle 19 to an appropriate range. According to a test conducted by the inventors, the ratio of the content thereof is preferably 0.01 to 1, more preferably 0.05 to 1, further preferably 0.1 to 1, and especially preferably 0.2 to 1.

In addition, similarly to a negative electrode active material layer of a typical lithium ion secondary battery, the negative electrode active material layer of the negative electrode disclosed herein can contain various arbitrary ingredients. For example, the negative electrode active material layer can contain a conductive material. As the conductive material, it is possible to suitably use carbon black such as acetylene black, and other carbon materials (graphite, carbon nanotube, and the like).

Further, the negative electrode active material layer may contain a resin material which can be used as the binder of the battery of this type in addition to the above-described binder which includes the water-soluble polymer lithium salt. Examples of the binder material other than the water-soluble polymer lithium salt include polyvinylidene fluoride (PVdF), polytetrafluoroethylene (PTFE), styrene butadiene rubber (SBR), and carboxymethyl cellulose (CMC). Note that the negative electrode disclosed herein only needs to contain the water-soluble polymer lithium salt and the sub-material particle which includes the metal compound having the hydroxyl group in the negative electrode active material layer. That is, PVdF or the like mentioned above is used as the binder and, additionally, the water-soluble polymer lithium salt may be added to the negative electrode active material layer as a thickening agent. In this case as well, it is possible to accelerate the supply of the Li ion to the negative electrode active material, and achieve a significant reduction in battery resistance.

Lithium Ion Secondary Battery

The negative electrode described above can be used in manufacture of the lithium ion secondary battery. That is, according to the present disclosure, there is provided a lithium ion secondary battery obtained by accommodating the negative electrode, a positive electrode, and a nonaqueous electrolyte solution in a battery case.

The positive electrode includes a positive electrode current collector, and a positive electrode active material layer provided on the surface of the positive electrode current collector. The positive electrode active material layer contains a positive electrode active material, a binder, and a conductive material. As the positive electrode active material, for example, an oxide having a layer structure or a spinel structure such as a lithium nickel oxide, a lithium cobalt oxide, a lithium manganese oxide, or a lithium iron oxide, and a phosphate having an olivine structure such as a lithium manganese phosphate or a lithium iron phosphate are suitably used. As the binder, polyvinylidene fluoride (PVdF) and polyethylene oxide (PEO) are suitably used. As the conductive material, a carbon material such as carbon black (e.g., acetylene black or Ketjen black) is suitably used.

The nonaqueous electrolyte solution typically contains a nonaqueous solvent and a supporting electrolyte. As the nonaqueous solvent, aprotic solvents such as carbonates, esters, ethers, nitriles, sulfones, and lactones are suitably used. Among them, carbonates such as, e.g., ethylene carbonate (EC), diethyl carbonate (DEC), dimethyl carbonate (DMC), and ethyl methyl carbonate (EMC) are suitably used. As the supporting electrolyte, LiPF₆ and LiBF₄ are suitably used. As the battery case, a battery case formed of a light metal material such as, e.g., aluminum is suitably used.

It is preferable that a separator is disposed between the negative electrode and the positive electrode. The separator can be a porous insulating sheet formed with a plurality of micropores (pore diameter: about 0.01 to 6 μm) which allow passage of a charge carrier (lithium ion). As the separator, it is possible to use insulating resins such as, e.g., polyethylene (PE), polypropylene (PP), polyester, and polyamide. Note that the separator may also be a multilayer sheet in which two or more layers of the above resin are stacked. In addition, a heat resistance layer (HRL layer) which contains a metal oxide such as alumina (Al₂O₃) may be formed on the surface of the separator.

Note that, in the present embodiment, the individual members other than the negative electrode 10 (e.g., the positive electrode, the separator, the nonaqueous electrolyte solution, and the battery case) similar to those used in the conventional typical lithium ion secondary battery can be used without limitations, and the individual members do not characterize the present invention. Accordingly, the detailed description thereof will be omitted.

Application of Lithium Ion Secondary Battery

The battery resistance of the lithium ion secondary battery disclosed herein is significantly reduced. Consequently, by taking advantage of such a feature, it is possible to suitably use the lithium ion secondary battery for an application in which the frequency of use in a low temperature environment is high and rapid charge and discharge are often performed. For example, the lithium ion secondary battery can be suitably used as a power source of a vehicle (drive power source). The type of the vehicle is not particularly limited, and examples of the type of the vehicle include a plug-in hybrid vehicle (PHV), a hybrid vehicle (HV), and an electric vehicle (EV). Note that the lithium ion secondary battery may also be used in the form of a battery pack in which a plurality of the lithium ion secondary batteries are connected in series and/or in parallel.

### TEST EXAMPLES

Hereinbelow, while test examples related to the negative electrode disclosed herein will be described, it is not intended to limit the present invention to such test examples.

A. First Test

### 1. Fabrication of Sample

### (1) Sample 1

First, a positive electrode active material (lithium/nickel/cobalt/manganese composite oxide), a conductive material (acetylene black), and a binder (PVdF) were added to an organic solvent (NMP) and the mixture was then kneaded, whereby a positive electrode paste was prepared. At this point, the ratio of each material was adjusted such that the positive electrode active material, the conductive material, and the binder satisfy a mass ratio of 87:10:3. Subsequently, the positive electrode paste was applied to the surface of a positive electrode current collector (made of aluminum, thickness: 20 μm) by using a die coater and was dried, and was then processed so as to have predetermined dimensions (length: 3,000 mm, width of positive electrode active material layer: 94 mm, width of uncoated portion: 20 mm, thickness: 70 μm), whereby a sheet-shaped positive electrode was fabricated.

On the other hand, a negative electrode active material (natural graphite) having a D₅₀ particle diameter of 20 μm, a binder, and a sub-material were added to a solvent (water) and the mixture was then kneaded by using a mixer granulator, whereby a negative electrode paste was prepared. In the present sample, a mixture of carboxymethyl cellulose (CMC-Na) and styrene butadiene rubber (SBR) was used as the binder (thickening agent), and a boehmite particle having a D₅₀ particle diameter of 10 μm was used as the sub-material. In addition, the ratio of each material was adjusted such that the negative electrode active material, the binder, and the sub-material satisfy a mass ratio of 88:2:10.

Subsequently, the negative electrode paste was applied to the surface of a negative electrode current collector (made of copper, thickness: 10 μm) by using the die coater and was dried, and was then processed so as to have predetermined dimensions (length: 3,300 mm, width of negative electrode active material layer: 100 mm, width of uncoated portion: 20 mm, thickness: 80 μm), whereby a sheet-shaped negative electrode was fabricated.

Next, a multilayer body in which the positive electrode and the negative electrode were stacked via a separator (thickness: 20 μm) in which three layers of PP/PE/PP were stacked was formed, and a wound electrode body was fabricated by winding the multilayer body. Subsequently, electrode terminals of the positive and negative electrodes were connected to the wound electrode body. Next, the wound electrode body was accommodated in a square case, and a nonaqueous electrolyte solution was injected into the case. In the present example, as the nonaqueous electrolyte solution, the nonaqueous electrolyte solution obtained by causing a mixed solvent containing EC, DMC, and EMC at a volume ratio of 1:1:1 to contain a supporting electrolyte (LiPF₆) at a concentration of 1 mol/L was used. Subsequently, a test lithium ion secondary battery having 5 Ah was obtained by sealing the case in which the wound electrode body and the nonaqueous electrolyte solution were accommodated and performing initial charge and discharge.

(2) Samples 2 to 17

Sixteen types of test lithium ion secondary batteries (samples 2 to 17) were fabricated with the same conditions and the same processes as those of sample 1 except that the material and the amount of each of the binder (thickening agent) and the sub-material of the negative electrode were different, as shown in Table 1 below.

2. Evaluation Test

The battery of each sample was charged until 3.7 V was reached, and the battery was then discharged for ten seconds at a discharge rate of 15 A (3 C) at a temperature of 0° C. Subsequently, a battery resistance was calculated based on a voltage drop amount ΔV (V) at this point. A battery resistance R was calculated based on Expression (1) shown below. The result of the calculation is shown in Table 1. Note that, in Table 1, the battery resistance of each sample is indicated by a relative value in the case where the measurement result of sample 1 is “1.00”.

R(Ω)=ΔV(V)/15 (A) (1)

TABLE 1

| | Binder (Thickening Agent) | | | | | | |
|---|---|---|---|---|---|---|---|
| | Material 1 | | Material 2 | | Sub-material | | |
| | | Amount | | Amount | | Amount | Battery |
| Sample | Type | (wt %) | Type | (wt %) | Type | (wt %) | Resistance |
| 1 | CMC-Na | 1 | SBR | 1 | Boehmite | 10 | 1.00 |
| 2 | CMC-Na | 10 | SBR | 1 | Boehmite | 10 | 2.33 |
| 3 | CMC-Li | 1 | SBR | 1 | — | — | 0.88 |
| 4 | CMC-Na | 1 | SBR | 1 | — | — | 0.90 |
| 5 | CMC-Li | 2 | — | — | — | — | 0.89 |
| 6 | PAA-Na | 1 | SBR | 1 | — | — | 0.87 |
| 7 | PAA-Na | 1 | SBR | 1 | Boehmite | 10 | 0.96 |
| 8 | PAA-Li | 1 | SBR | 1 | — | — | 0.91 |
| 9 | PAA-Li | 2 | — | — | — | — | 0.91 |
| 10 | — | — | PVDF | 2 | Boehmite | 10 | 0.95 |
| 11 | — | — | PVP | 2 | Boehmite | 10 | 0.94 |
| 12 | — | — | PVA | 2 | Boehmite | 10 | 0.92 |
| 13 | CMC-Li | 1 | SBR | 1 | Boehmite | 10 | 0.56 |
| 14 | CMC-Li | 2 | — | — | Boehmite | 10 | 0.52 |
| 15 | PAA-Li | 1 | SBR | 1 | Boehmite | 10 | 0.57 |
| 16 | PAA-Li | 2 | — | — | Boehmite | 10 | 0.51 |
| 17 | Alginic Acid-Li | 1 | SBR | 1 | Boehmite | 10 | 0.58 |

As shown in Table 1, as the result of comparison of the battery resistances of samples 1 to 17, it was determined that the battery resistance was significantly reduced in each of samples 13 to 16. From this, it was found that it was possible to accelerate the supply of the Li ion to the negative electrode active material and suitably reduce the battery resistance by adding the water-soluble polymer lithium salt and the sub-material particle which included the metal compound having the hydroxyl group to the negative electrode active material layer. In addition, it was determined that each of a carboxymethyl cellulose lithium salt (CMC-Li), a polyacrylic acid lithium salt (PAA-Li), and an alginic acid lithium salt was suitable as the water-soluble polymer lithium salt.

B. Second Test

Nine types of test lithium ion secondary batteries (samples 18 to 26) were fabricated with the same conditions and the same processes as those of sample 13 in the first test except that the material of the sub-material was different, as shown in Table 2.

Thereafter, the battery resistance of each sample was calculated according to the same procedure as that in the first test. The result of the calculation is shown in Table 2.

TABLE 2

| | Binder (Thickening Agent) | | | | | | |
|---|---|---|---|---|---|---|---|
| | Material 1 | | Material 2 | | Sub-material | | |
| | | Amount | | Amount | | Amount | Battery |
| Sample | Type | (wt %) | Type | (wt %) | Type | (wt %) | Resistance |
| 18 | CMC-Li | 1 | SBR | 1 | Boehmite | 10 | 0.56 |
| 19 | CMC-Li | 1 | SBR | 1 | Alumina | 10 | 0.58 |
| 20 | CMC-Li | 1 | SBR | 1 | Aluminum Hyrdroxide | 10 | 0.53 |
| 21 | CMC-Li | 1 | SBR | 1 | Zirconia | 10 | 0.59 |
| 22 | CMC-Li | 1 | SBR | 1 | Magnesia | 10 | 0.59 |
| 23 | CMC-Li | 1 | SBR | 1 | Titania | 10 | 0.89 |
| 24 | CMC-Li | 1 | SBR | 1 | LTO | 10 | 0.88 |
| 25 | CMC-Li | 1 | SBR | 1 | Silica | 10 | 0.95 |
| 26 | CMC-Li | 1 | SBR | 1 | Aluminum Nitride | 10 | 0.95 |

As shown in Table 2, it was determined that the battery resistance was significantly reduced in each of samples 18 to 22. From this, it was determined that each of boehmite, alumina, zirconia, magnesia, and aluminum hydroxide was suitable as the material of the sub-material particle.

C. Third Test

Four types of test lithium ion secondary batteries (samples 27 to 30) were fabricated with the same conditions and the same processes as those of sample 13 in the first test except that the D₅₀ particle diameter of the sub-material particle (boehmite particle) was different, as shown in Table 3.

Subsequently, the battery resistance of each sample was calculated according to the same procedure as that in the first test. The result of the calculation is shown in Table 3.

TABLE 3

| | Binder (Thickening Agent) | | | | | | | |
|---|---|---|---|---|---|---|---|---|
| | Material 1 | | Material 2 | | Sub-material | | | |
| | | Amount | | Amount | | D₅₀ | Amount | Battery |
| Sample | Type | (wt %) | Type | (wt %) | Type | (μm) | (wt %) | Resistance |
| 27 | CMC-Li | 1 | SBR | 1 | Boehmite | 1 | 10 | 0.56 |
| 28 | CMC-Li | 1 | SBR | 1 | Boehmite | 0.5 | 10 | 0.55 |
| 29 | CMC-Li | 1 | SBR | 1 | Boehmite | 1.5 | 10 | 0.63 |
| 30 | CMC-Li | 1 | SBR | 1 | Boehmite | 2 | 10 | 0.73 |

As shown in Table 3, among samples 27 to 30, the battery resistance was significantly reduced especially in each of samples 27 to 29. From this, it was found that it was possible to reduce the battery resistance more suitably by setting the D₅₀ particle diameter of the sub-material particle to 1.5 μm or less.

D. Fourth Test

Five types of test lithium ion secondary batteries (samples 31 to 35) were fabricated with the same conditions and the same processes as those of sample 13 in the first test except that the amount of CMC-Li was different, as shown in Table 4.

Subsequently, the battery resistance of each sample was calculated according to the same procedure as that in the first test described above. The result of the calculation is shown in Table 4.

TABLE 4

| | Binder (Thickening Agent) | | | | | | | | |
|---|---|---|---|---|---|---|---|---|---|
| | Material 1 | | Material 2 | | Material 3 | | Sub-material | | |
| | | Amount | | Amount | | Amount | | Amount | Battery |
| Sample | Type | (wt %) | Type | (wt %) | Type | (wt %) | Type | (wt %) | Resistance |
| 31 | CMC-Li | 1 | — | — | SBR | 1 | Boehmite | 10 | 0.56 |
| 32 | CMC-Li | 0.1 | CMC-Na | 0.9 | SBR | 1 | Boehmite | 10 | 0.65 |
| 33 | CMC-Li | 10 | — | — | SBR | 1 | Boehmite | 10 | 0.53 |
| 34 | CMC-Li | 0.05 | CMC-Na | 0.95 | SBR | 1 | Boehmite | 10 | 0.92 |
| 35 | CMC-Li | 15 | — | — | SBR | I | Boehmite | 10 | 0.83 |

As shown in Table 4, among samples 31 to 35, the battery resistance was significantly reduced especially in each of samples 31 to 33. From this, it was found that it was possible to reduce the battery resistance more suitably by setting the content of the water-soluble polymer lithium salt to 0.1 to 10 wt % when the total weight of the negative electrode active material layer was 100 wt %.

E. Fifth Test

Five types of test lithium ion secondary batteries (samples 36 to 40) were fabricated with the same conditions and the same processes as those of sample 13 in the first test except that the amount of the sub-material (boehmite particle) was different, as shown in Table 5.

Subsequently, the battery resistance of each sample was calculated according to the same procedure as that in the first test described above. The result of the calculation is shown in Table 5.

TABLE 5

| | Binder (Thickening Agent) | | | | | | |
|---|---|---|---|---|---|---|---|
| | Material 1 | | Material 2 | | Sub-material | | Battery |
| | | Amount | | Amount | | Amount | Resis- |
| Sample | Type | (wt %) | Type | (wt %) | Type | (wt %) | tance |
| 36 | CMC-Li | 1 | SBR | 1 | Boehmite | 10 | 0.56 |
| 37 | CMC-Li | 1 | SBR | 1 | Boehmite | 1 | 0.58 |
| 38 | CMC-Li | 1 | SBR | 1 | Boehmite | 20 | 0.62 |
| 39 | CMC-Li | 1 | SBR | 1 | Boehmite | 0.5 | 0.86 |
| 40 | CMC-Li | 1 | SBR | 1 | Boehmite | 25 | 0.94 |

As shown in Table 5, among samples 36 to 40, the battery resistance was significantly reduced especially in each of samples 36 to 38. From this, it was found that it was possible to reduce the battery resistance more suitably by setting the content of the sub-material particle to 1 to 20 wt % when the total weight of the negative electrode active material layer was 100 wt %.

F. Sixth Test

Eight types of test lithium ion secondary batteries (samples 41 to 48) were fabricated with the same conditions and the same processes as those of sample 13 in the first test except that the ratio of the water-soluble polymer lithium salt (CMC-Li) to the sub-material (boehmite) was different, as shown in Table 6.

Subsequently, the battery resistance of each sample was calculated according to the same procedure as that in the first test described above. The result of the calculation is shown in Table 6.

TABLE 6

| | Binder (Thickening Agent) | | | | | | | | Polymer | |
|---|---|---|---|---|---|---|---|---|---|---|
| | Material 1 | | Material 2 | | | | | | Weight/ | |
| | (Water-soluble Polymer 1) | | (Water-soluble Polymer 2) | | Material 3 | | Sub-Material | | Sub- | |
| | | Amount | | Amount | | Amount | | Amount | material | Battery |
| Sample | Type | (wt %) | Type | (wt %) | Type | (wt %) | Type | (wt %) | Weight | Resistance |
| 41 | CMC-Li | 1 | — | — | SBR | 1 | Boehmite | 10 | 0.10 | 0.56 |
| 42 | CMC-Li | 2 | — | — | — | — | Boehmite | 10 | 0.20 | 0.52 |
| 43 | CMC-Li | 0.1 | CMC-Na | 0.9 | SBR | 1 | Boehmite | 10 | 0.01 | 0.65 |
| 44 | CMC-Li | 10 | — | — | SBR | 1 | Boehmite | 10 | 1.00 | 0.53 |
| 45 | CMC-Li | 15 | — | — | SBR | 1 | Boehmite | 10 | 1.50 | 0.83 |
| 46 | CMC-Li | 1 | — | — | SBR | 1 | Boehmite | 1 | 1.00 | 0.58 |
| 47 | CMC-Li | 1 | — | — | SBR | 1 | Boehmite | 20 | 0.05 | 0.62 |
| 48 | CMC-Li | 1 | — | — | SBR | 1 | Boehmite | 0.5 | 2.00 | 0.86 |

As shown in Table 6, among samples 41 to 48, the battery resistance was significantly reduced especially in each of samples 41 to 44 and samples 46 and 47. From this, it was found that it was possible to reduce the battery resistance more suitably by setting the ratio of the amount of the water-soluble polymer lithium salt to the amount of the sub-material particle to a range of 0.01 to 1.

G. Seventh Test

Four types of test lithium ion secondary batteries (samples 49 to 52) were fabricated with the same conditions and the same processes as those of sample 13 in the first test except that the material of each of the binder and the sub-material particle in the negative electrode was different, as shown in Table 7.

Subsequently, the battery resistance of each sample was calculated according to the same procedure as that in the first test described above. The result of the calculation is shown in Table 7.

TABLE 7

| | Binder (Thickening Agent) | | | | Sub-material | | | | |
|---|---|---|---|---|---|---|---|---|---|
| | Material 1 | | Material 2 | | Material 1 | | Material 2 | | |
| | | Amount | | Amount | | Amount | | Amount | Battery |
| Sample | Type | (wt %) | Type | (wt %) | Type | (wt %) | Type | (wt %) | Resistance |
| 49 | CMC-Li | 1 | SBR | 1 | Boehmite | 10 | LTO | 10 | 0.59 |
| 50 | CMC-Li | 1 | SBR | 1 | Boehmite | 10 | SiO | 10 | 0.62 |
| 51 | CMC-Na | 1 | SBR | 1 | Boehmite | 10 | LTO | 10 | 1.01 |
| 52 | CMC-Na | 1 | SBR | 1 | Boehmite | 10 | SiO | 10 | 1.05 |

As shown in Table 7, it was determined that the battery resistance was significantly reduced in each of samples 49 and 50. From this, it was found that, when the water-soluble polymer lithium salt such as CMC-Li and the sub-material particle having the hydroxyl group such as boehmite were contained in the negative electrode active material layer, the battery resistance was significantly reduced even when the material which allowed the insertion and extraction of the lithium ion such as LTO or SiO was added as the second sub-material particle. In addition, from the result of the present test, it is expected that the battery resistance reduction effect by the negative electrode disclosed herein can be suitably exerted even in the case where LTO or SiO is used as the negative electrode active material.

While the specific examples of the present invention have been described in detail thus far, the specific examples are only illustrative, and are not intended to limit the scope of claims. Techniques described in the scope of claims encompass various modifications and changes to the specific examples described above.

What is claimed is:

1. A negative electrode for a lithium ion secondary battery, comprising:
a negative electrode current collector, and
a negative electrode active material layer provided on a surface of the negative electrode current collector, wherein
the negative electrode active material layer contains:
a negative electrode active material including a material capable of inserting and extracting a lithium ion;
a water-soluble polymer lithium salt; and
a sub-material particle including a metal compound which has a hydroxyl group.

2. The negative electrode for a lithium ion secondary battery according to claim 1, wherein
the sub-material particle includes at least one selected from the group consisting of a metal oxide and a metal hydroxide.

3. The negative electrode for a lithium ion secondary battery according to claim 2, wherein
the sub-material particle includes at least one selected from the group consisting of alumina, boehmite, aluminum hydroxide, zirconia, and magnesia.

4. The negative electrode for a lithium ion secondary battery according to claim 1, wherein
the water-soluble polymer lithium salt includes at least one selected from the group consisting of a carboxymethyl cellulose lithium salt, a polyacrylic acid lithium salt, and an alginic acid lithium salt.

5. The negative electrode for a lithium ion secondary battery according to claim 1, wherein
a D₅₀ particle diameter of the sub-material particle is not more than 1.5 μm.

6. The negative electrode for a lithium ion secondary battery according to claim 1, wherein
a content of the water-soluble polymer lithium salt is 0.1 to 10 wt % when a total weight of the negative electrode active material layer is 100 wt %.

7. The negative electrode for a lithium ion secondary battery according to claim 1, wherein
a content of the sub-material particle is 1 to 20 wt % when the total weight of the negative electrode active material layer is 100 wt %.

8. The negative electrode for a lithium ion secondary battery according to claim 1, wherein
a ratio of the content of the water-soluble polymer lithium salt to the content of the sub-material particle is 0.01 to 1.
